(19) United States
(12) Patent Application Publication
(10) Pub. No.: US 2005/0108684 A1
(43) Pub. Date: May 19, 2005

(54) Method and system for generating an application object repository from application framework metadata

(76) Inventors: Matthias Eberhard Sohn, Speyer (DE); A.R. Sathyanarayanan, Banaglore (IN)

Correspondence Address: KENYON & KENYON, ONE BROADWAY, NEW YORK, NY, 10004, US

(21) Appl. No.: 10/713,872

(22) Filed: Nov. 14, 2003

(51) Int. Cl. G06F 9/44

(52) U.S. Cl. 717/120; 717/101

(57) ABSTRACT

The present invention provides a method and system for the generation of an application object repository from application framework metadata. In order to achieve this generation, application object repository is itself conceived as a framework that may be extended through application repository framework metadata.

### FIELD OF THE INVENTION

The present invention relates to the areas of computer software, software engineering and development. In particular, the present invention provides a method and system for generating an application object repository from application framework metadata.

### BACKGROUND INFORMATION

In complex software development environments, it is desirable to provide an architecture that provides extensibility, code reuse, etc. FIG. 1, which is prior art, depicts a software development paradigm. Application framework 215 defines a common architecture for applications 140 by providing services and functionalities that may be consumed by an application 140 running on framework 215. Application framework 215 defines a format or language for developed applications by providing a set of constructs and relationships between them.

Application framework 215 includes core application framework 215(1) and application framework metadata 215(2). Core application framework 215(1) provides a base set of constructs and semantics, which may be used to structure application 140. In addition, application framework developer 125 may define application framework metadata 215(2) through which various framework extensions, customizations, etc., may be introduced to provide increased functionality to the application framework 215. Under this paradigm, the functionalities of application framework 215 may evolve over time to provide functionalities and extensions defined through the use of application framework metadata 215(2).

Application developer 150 may utilize application modeling environment 160 to define application 140 against the constructs and relations defined by application framework 215. Application 140 may be represented as application metadata 190, which is stored in application object repository 170. Application metadata 190 comprises development objects and their relations, which application developer 150 has defined in application modeling environment 160 in order to model application 140.

In order to efficiently utilize the constructs and objects comprising application framework metadata 215(2) in modeling an application, it is desirable to provide application object repository 170, which may be an object database. Application object repository 170 provides for archival of previously defined application metadata 190, which may then be reused. In addition to archival of development objects, application object repository 170 provides a series of services for working with the development objects that aid in application development such as change management, versioning, persistence, navigation, etc.

From the definitions provided via application modeling environment 160, which is represented as metadata 190, application 140 is then generated. Application 140 comprises a plurality of runtime objects, which may include any executables, binaries, dlls, resources, BLOBs, (“Binary Large Objects”), etc.

As application object repository 170 is an object database, it allows application developer 150 to access application metadata 190 in a manner consistent with the object nature of the application objects themselves, even though the data is persisted in application object repository 170 in a relational structure.

The relationship between the evolution of application framework through introduction of application framework metadata 215(2) and application object repository is important as it is desirable to update application object repository 170 if changes are made to application framework 215. The structure of application object repository 170 includes a repository schema 170(1) representing the tables (columns and rows) of the database for storing application metadata 190 and a runtime component 170(2) that allows the relational database to be accessed in an object format. As will be understood by practitioners in the art, the schema is the structure of a database system and defines the tables and fields in each table. The tables relates to the arrangement of data in rows and columns. This database schema is then populated by instances of these objects (metadata 190) defined by application developer 150, these instances and their relations defining a software application.

The structure of application object repository 170 and therefore application object repository schema 170(1) and application object repository runtime 170(2) depend upon constructs and relations defined through application framework 215. That is, the storage of application metadata 190 in application object repository 170 as well as the services provided by application object repository 170 such as versioning, change management, etc. have to conform to the semantics of application framework 215.

As application framework 215 evolves via the definition of application framework metadata 130(2), a significant challenge exists to generate application object repository 170 to reflect the evolving application framework 215. Furthermore, as application framework 215 evolves, it is also necessary to perform migration of the application metadata 190 previously stored in application object repository 170. In particular, as application framework 215 changes, it is necessary to generate both application object repository schema 170(1) and application object repository runtime 170(2).

Known methods for facilitating the modeling of objects against a particular framework is to provide a development or visual studio. A development or visual studio typically comprises a complex client application through which objects are modeled against the underlying framework. An advantage of such development studios is that they allow the capture of very rich semantics.

On the other hand UML (“Unified Modeling Language”) and Rational Rose, which allows visualization of a UML model, provides an industry-standard toolset for specifying and visualizing the structure of software systems, essentially providing a “blueprint” for the software edifice. However, compared to development studios, UML offers a much more limited set of semantics for specifying a software architecture.

### SUMMARY OF THE INVENTION

The present invention provides a method and system for the generation of an application object repository 170 from application framework metadata 215(2). In order to achieve this generation, application object repository 170 is itself conceived as a framework that may be extended through application repository framework metadata. In the same way that application framework 215 may evolve by defining extensions via application framework metadata 215(2), the application repository framework may be extended by defining application object repository metadata. According to one embodiment of the present invention, this is achieved by introduction of a common modeling language which is used to model both application framework metadata 215(2) and the application repository itself (i.e., a set of constructs, semantics, objects, etc.) through which the application object repository framework may be modeled or defined.

According to the present invention, a meta-model architecture is adopted that provides for the definition of a meta-model for application framework 215 (herein referred to as “M2”), and thereby serves as an application framework modeling language. The application framework metadata is then referred to as the M1 meta-level. The meta-model architecture provides for an additional meta-model that serves as a language for modeling the application framework modeling language (herein referred to as “M3”). Through the adoption of this formalism, M2 serves as a repository framework compliant modeling language since the repository is structured as a function of application framework metadata 215(2) and thus the language for describing application framework (M2) describes the underlying constructs of the repository framework. Furthermore, the introduction of meta-levels (M2) and (M3) provides information necessary for performing transformations on the application framework metadata (M1) as M2 defines the semantics of M1, while M3 describes the constructs and semantics of M2. Thus, the M2 and M3 meta-levels provide semantic relationships necessary for transforming the M1 metadata. According to the present invention, a suitable set of transformations on the M1 metadata (215(2)) is provided to generate application object repository 170 itself.

According to the present invention, a repository framework metadata generator includes a metadata workbench, a metadata engine and a generator. According to one embodiment, the metadata workbench provides a visual editor for defining the application framework metadata. In one embodiment, the visual editor exposes the M2 meta-level constructs and semantics to the application framework developer via the Rational Rose visual editor and UML (“Unified Modeling Language”). The extension of the UML to incorporate the M2 information is referred to herein as AML (“Application Modeling Language”). According to this embodiment, upon receiving the application framework metadata via the metadata workbench, the metadata engine transforms the received application framework metadata in UML/AML into XML (“Extensible Markup Language”). The UML-XML transformation is achieved by utilizing the M2 and M3 meta-level information. The generator then generates an application object repository schema script by performing an XSL (“Extensible Style Language”) on the XML data. In addition, the generator generates an application object repository source file by performing an XSL transformation on the same XML data. The application object repository schema 170(1) is then generated from the repository schema script. The generator further produces the application object repository runtime 170(2) by applying the application object repository source files to a compiler.

The present invention also provides for the migration of pre-existing application metadata in application object repository 170 by utilizing semantic information concerning the semantics of the application framework metadata extracted from the M2 and M3 meta-levels.

### BRIEF DESCRIPTION OF THE DRAWINGS

FIG. 1, which is prior art, depicts a software development paradigm.

FIG. 2 depicts a relationship between an application framework and a repository framework according to one embodiment of the present invention.

FIG. 3a depicts a meta-model architecture according to one embodiment of the present invention.

FIG. 4 depicts a relationship between the M0, M1 and M2 meta-levels with respect to the schema of the repository schema 170(1).

FIG. 5a depicts a M2 model for an object repository according to one embodiment of the present invention.

FIG. 6 depicts an M3 model used to define an XML meta-data schema according to one embodiment of the present invention.

FIG. 7 depicts a functioning of a repository generator in relation to an application framework development environment and an application development environment according to one embodiment of the present invention.

FIG. 8 depicts a detailed functioning of repository generator FIG. 9 shows a detailed architecture for a repository generator according to one embodiment of the present invention.

FIG. 10 depicts a generator utilizing XML/XSL technology according to one embodiment of the present invention.

FIG. 11 shows the use of meta-ARS 1105(5), which is designed to store a history of ARS models (i.e., object repository models).

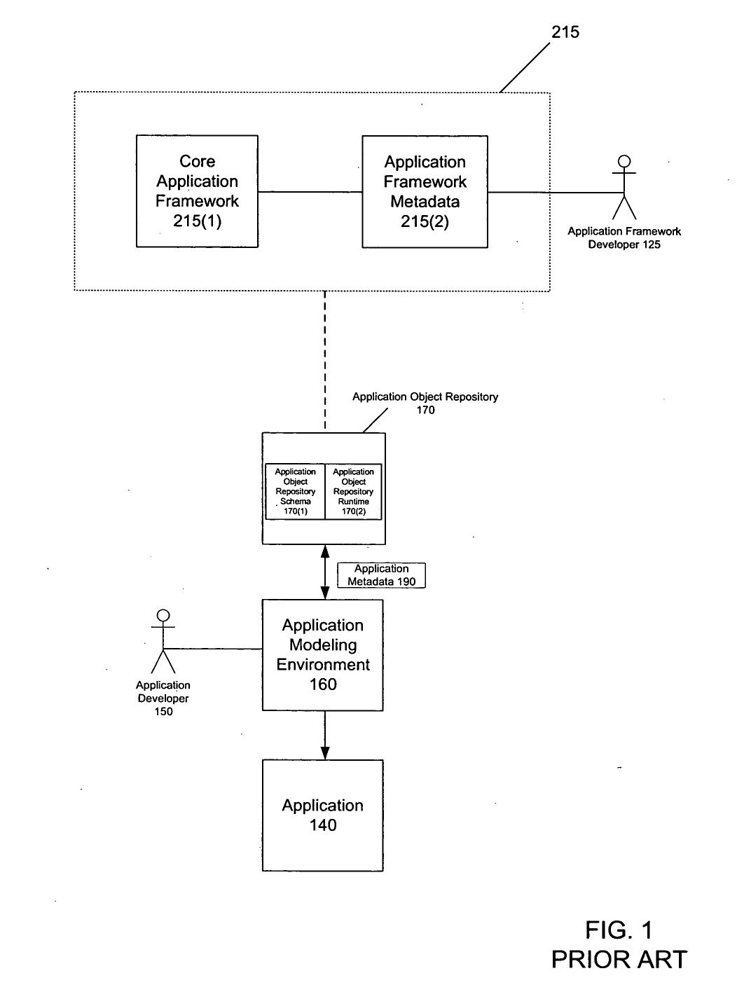

### DETAILED DESCRIPTION

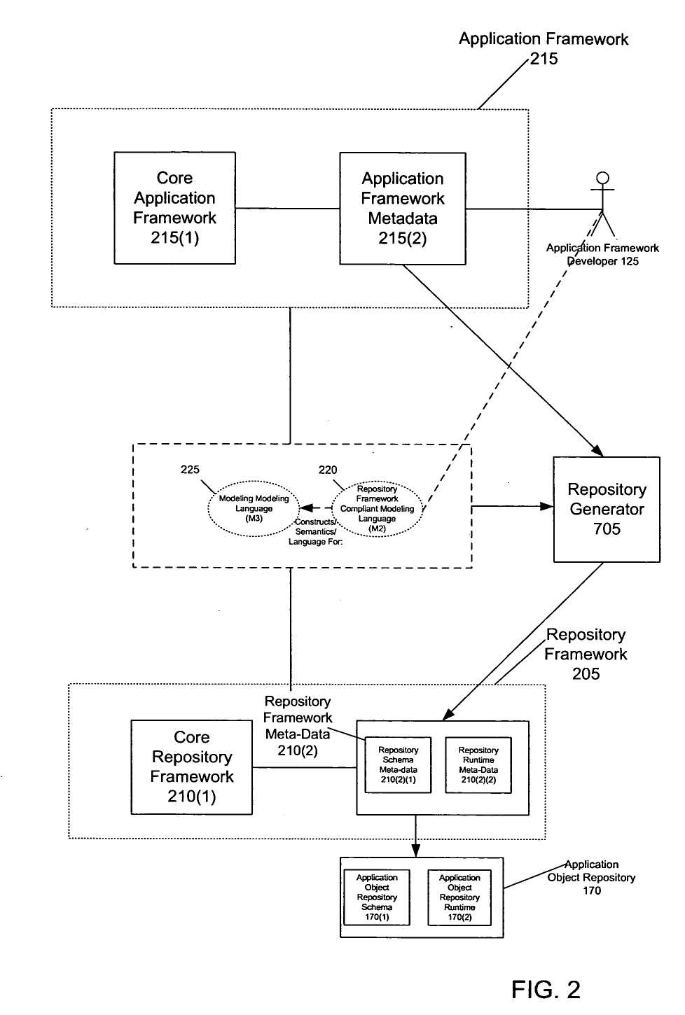

According to the present invention, object repository 170 is conceived of as a framework itself. FIG. 2 depicts a relationship between an application framework and a repository framework according to one embodiment of the present invention. As shown in FIG. 2, application framework 215 includes core application framework 215(1) and application framework metadata 215(2).

FIG. 2 also shows repository framework 205. Repository framework includes core repository framework 210(1) and repository framework metadata 210(2). Repository framework metadata 210(2) includes repository schema meta-data 210(2)(1) and repository runtime meta-data 210(2)(2). Repository schema meta-data 210(2)(1) pertains to meta-data for defining extensions to the schema of object repository framework 205. Repository runtime meta-data 210(2)(2) pertains to meta-data for defining extensions to runtime services of object repository framework 205. Repository schema meta-data 210(2)(1) and repository runtime meta-data 210(2)(2) are utilized to generate respectively application object repository schema 170(1) and application object repository runtime 170(2).

According to the present invention, repository generator 705 receives application framework meta-data 215(2). Utilizing repository framework compliant modeling language 220 and modeling-modeling language 225, repository generator generates repository framework meta-data 210(2), which includes repository schema meta-data 210(2)(1) and repository runtime meta-data 210(2)(2). Thus, repository schema meta-data 210(2)(1) and repository runtime meta-data 210(2)(2) are generated utilizing application framework meta-data 215(2) as an input. According to the present invention, this is achieved by virtue of providing a repository framework compliant modeling language 220 to application developer. Repository framework compliant modeling language 220 is defined via semantics and constructs provided by modeling modeling language 225. Thus, as reflected in FIG. 2, repository framework compliant modeling language 220 and modeling-modeling language 225 allow correlation between repository framework 205 and application framework 205. As will become evident as the invention is further described, repository framework compliant modeling language 220 and language modeling language 225 are utilized to transform application framework metadata 215(2) into repository framework metadata 210(2) by repository generator 705. The structure and function of application generator 705 will be described in detail below.

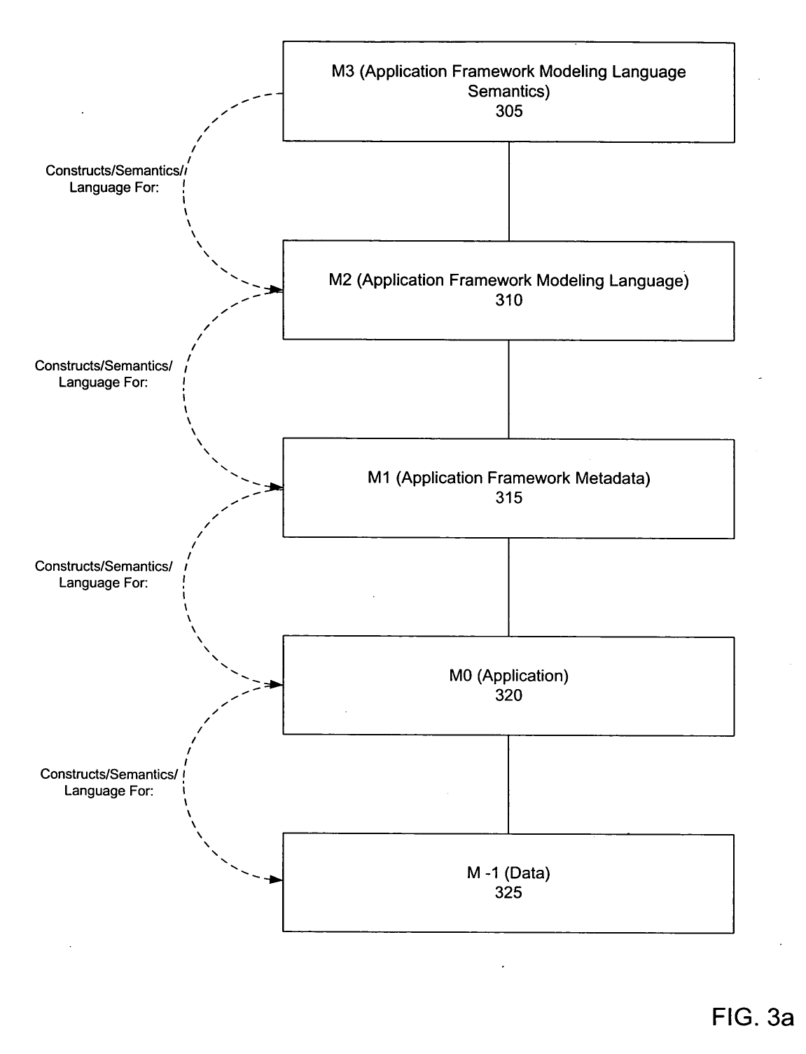

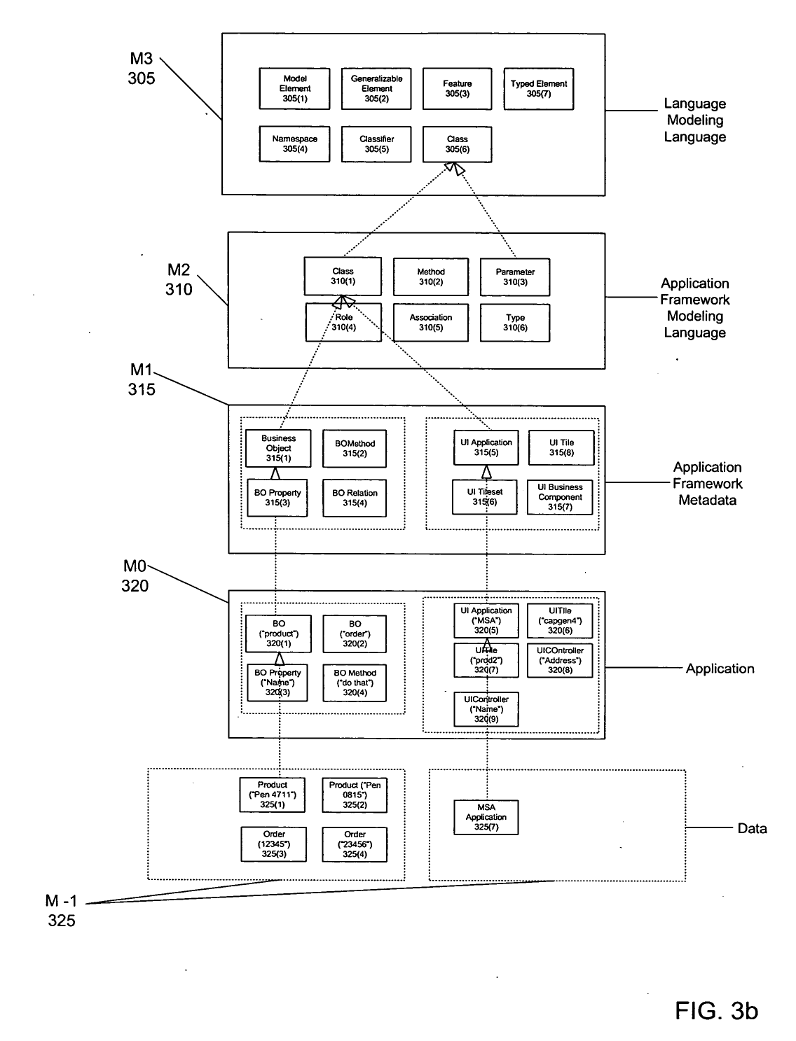

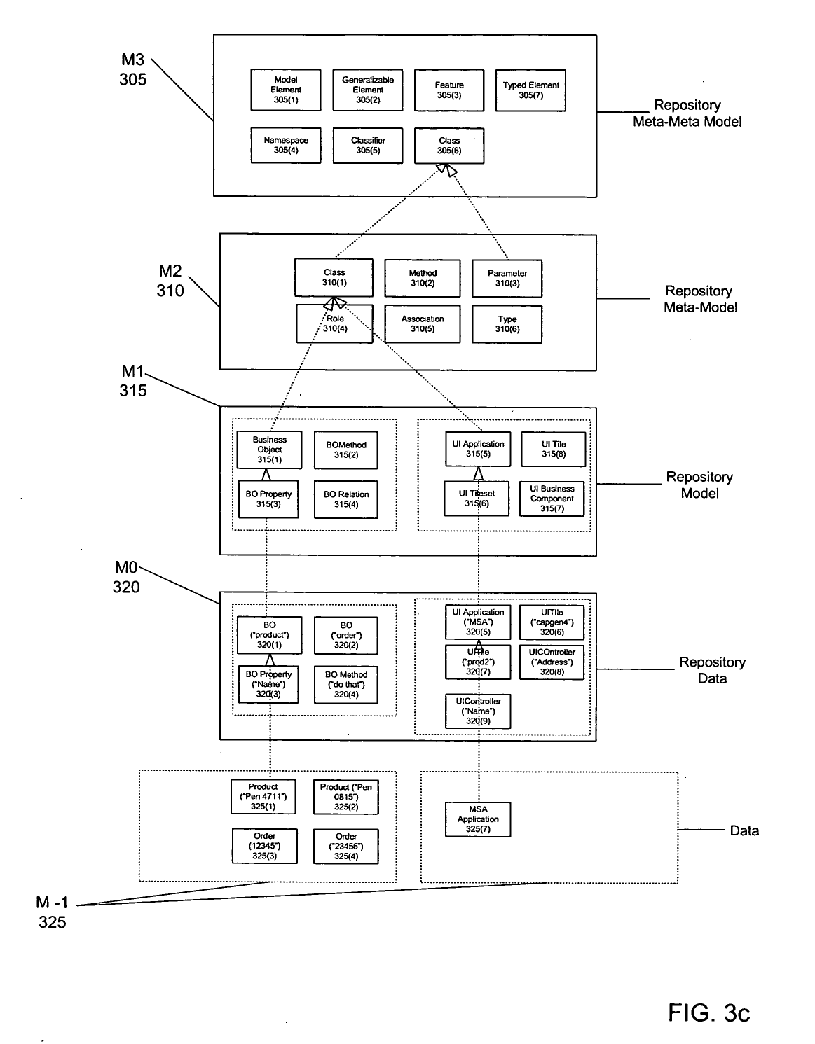

FIG. 3a depicts a meta-model architecture according to one embodiment of the present invention. The meta-model architecture shown in FIG. 3a is loosely modeled on the MOF (“Meta-Object Facility”) and UML. As will be recognized by skilled practitioners, the UML (“Unified Modeling Language”) defines a graphical language for visualizing, specifying, constructing and documenting the artifacts of distributed object systems. MOF defines a set of CORBA IDL interfaces that can be used to define and manipulate a set of interoperable meta-models and their corresponding models. The MOF specification is intended to provide an open-ended information capability. Alternatively, the MOF model can be used as a model for defining information models. This feature allows the designer to define information models that differ from the philosophy or details of the MOF model. In this context, the MOF Model is referred to as a meta-meta-model because it is being used to define meta-models such as the UML.

Each model layer is comprised of metadata, which is informally aggregated as models. The term “meta-data” is used to refer to data whose purpose is to describe other data. The term “meta-model” is used to refer to a model of some kind of meta-data.

Referring to FIG. 3a, the meta-model architecture includes five levels M-1, M0, M1, M2 and M3. Note that each level directly above a particular level provides constructs/semantics (i.e., a language) for the level below. Thus, for example, the M2 level 210 provides constructs/semantics for the M1 level 315(1) and thus serves as a language for defining the M1 level. Similarly, M3 meta-level 305 provides constructs/semantics for defining relations between the constructs at M2 level 310.

In general, M3 305 pertains to a meta-meta-model, which is designed for the modeling of modeling languages. M2 310 pertains to the language for modeling application framework metadata 215(2) and simultaneously serves as a compliant language for modeling repository framework metadata 210(2). M1 315 pertains to application framework metadata 215(2) itself and simultaneously serves as a repository object model, which is a schema of the repository database. M0 320 pertains to modeled application itself and therefore relates to the application metadata 190 stored in repository 170 (development objects). Finally, M-1 325 relates to the actual data generated at runtime for application 140.

FIG. 3b shows how the meta-model shown in FIG. 3a may be utilized to model an application framework according to one embodiment of the present invention. The particular example depicted in FIG. 3b relates to modeling of a CRM (“Customer Relations Management”) application. However, it should be understood that the meta-model architecture may be utilized to model any type of application framework. Thus, as reflected in FIG. 3a, meta-level M-1 (corresponding to the runtime generated data produced by application 140) may include such objects as “Pen 4711” 325(1), “Order 12345” 325(3), etc., which are instantiations of development objects (application meta-data 190) defined by application developer 150 at meta-level M0 320.

Meta-level M0 320 pertains to application meta-data 190 defined by application developer 150. Thus, for example, “Pen 4711” 325(1) at M-1 325 instantiates development object “Product” 320(1) at M0 320. Similarly, “Order 12345” 325(3) at M-1 instantiates development object “Order” 320(2) at M0.

Meta-level M1 pertains to meta-data for application framework 215(2). According to the example shown in FIG. 3a, application framework meta-data 215 defines the constructs of “Business Object” 315(1), “BO Method” 315(2), “BO Property” 315(3) and “BO Relation 315(4), which collectively serve as constructs for modeling application meta-data 190 at M0 320. The nature of the particular constructs shown for M1 315 is not important for present purposes. However, it is to be understood that some of these constructs such as “Business Object” 315(1), “BO Method” 315(2), etc. relate to modeling a particular application logic and structure, while others such as “UI Application” 315(5), “UI Tile” 315(8), “UI Tileset” 315(6) and “UI Business Component” 315(7) may relate to modeling particular user interface components of application 140.

Meta-level M2 pertains to a language for modeling application framework meta-data at M1 315. With respect to the particular example shown in FIG. 3a, meta-level M2 defines constructs including “Class” 310(1), “Method” 310(2), “Parameter” 310(3), “Role” 310(4), “Association” 310(5) and “Type” 310(6). These exemplary constructs define semantics for defining the particular constructs at M1 315 such as “Business Object” 315(1), etc.

Meta-level M3 305 defines a set of constructs, which are utilized to define relations between the constructs at M2 310. According to the particular example shown in FIG. 3b, M3 305 includes constructs “Model Element” 305(1), “Generalizable Element” 305(2), “Feature” 305(3), “Namespace” 305(4), “Classifier” 305(5), “Class” 305(6) and “Typed Element” 305(7). Thus, for example, “Class” 310(1) and “Parameter” 310(3) at M2 310 are instances of “Class” 305(6) at M3 305.

FIG. 3c depicts how the meta-levels shown in FIGS. 3a-3b may also be applied to model an object repository according to one embodiment of the present invention. A particular object repository contemplated is herein referred to as ARS (“Application Repository Services”), which provides a database of development objects and associated services such as navigation, versioning, configuration management, etc.) However, it is to be understood that the present invention may be utilized to model any type of object repository.

Referring to FIG. 3c, M3 305 is a meta-meta-model designed for the modeling of modeling languages and thus according to the present invention simultaneously serves as a repository meta-meta model. M2 310 is a meta-model describing the object repository modeling language itself. Meta-level M2 310 may be viewed as a subset of UML. M1 315 relates to the object repository model, which is the schema of the repository database. M0 320 relates to the repository data itself, which is instantiated objects from M1 315. M-1, although shown in FIG. 3c, does not relate to the object repository 170 but is shown for illustrative purposes only in comparison with FIG. 3c.

Referring to FIGS. 3b-3c, it is evident that a relationship exists between the meta-model for the application framework 215 (see FIG. 3b) an the meta-model for repository 170 (see FIG. 3c). In particular M2 which is a meta-language for modeling application framework 215 also serves as a repository compliant modeling language. Similarly M3 is also compliant with respect the application meta-model (see FIG. 3b) and the repository meta-model (see FIG. 3c). According to one embodiment of the present invention, this relationship is utilized to provide generation of the repository 170 from application framework metadata 215(2). In particular, as the invention is further described, an embodiment will be described wherein M3 305 is utilized along with M2 310, which are common to application meta-model (FIG. 3b) and repository meta-model (FIG. 3c) are utilized to generate an intermediate representation of repository framework meta-data 210(2) from application framework meta-data 215(2) (M1). This intermediate representation is then utilized to generate repository framework meta-data 210(2) including both repository schema meta-data 210(2)(1) and repository runtime meta-data 210(2)(2). Repository schema meta-data 210(2)(1) and repository runtime meta-data 210(2) are then utilized respectively to generate application object repository schema 170(1) and application object repository runtime 170(2) comprising application object repository 170.

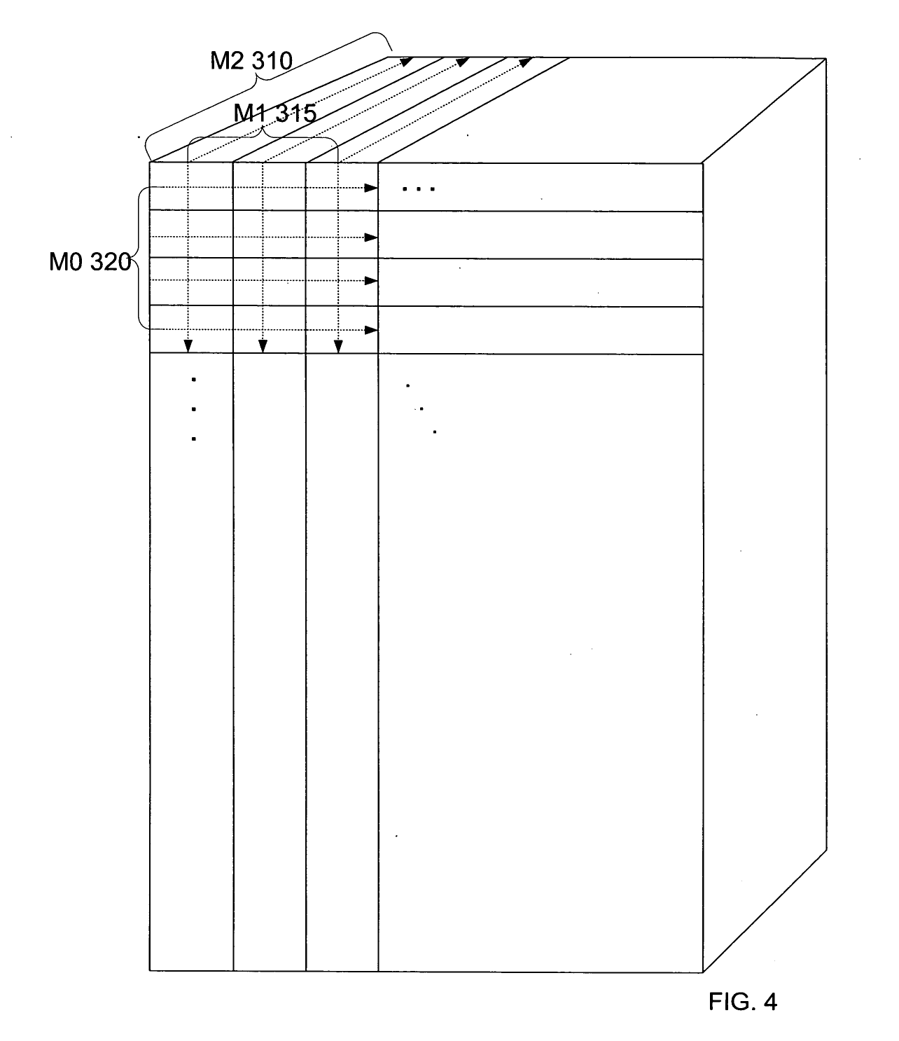

FIG. 4 depicts a relationship between the M0, M1 and M2 meta-levels with respect to the schema of the repository schema 170(1). M1 315 meta-level pertains to the columns of the database tables, the schema of repository 170. M0 320 pertains to the rows or actual data in application object repository 170. M2 310 pertains to a relationship between columns of the database—i.e., semantics for the application object repository schema.

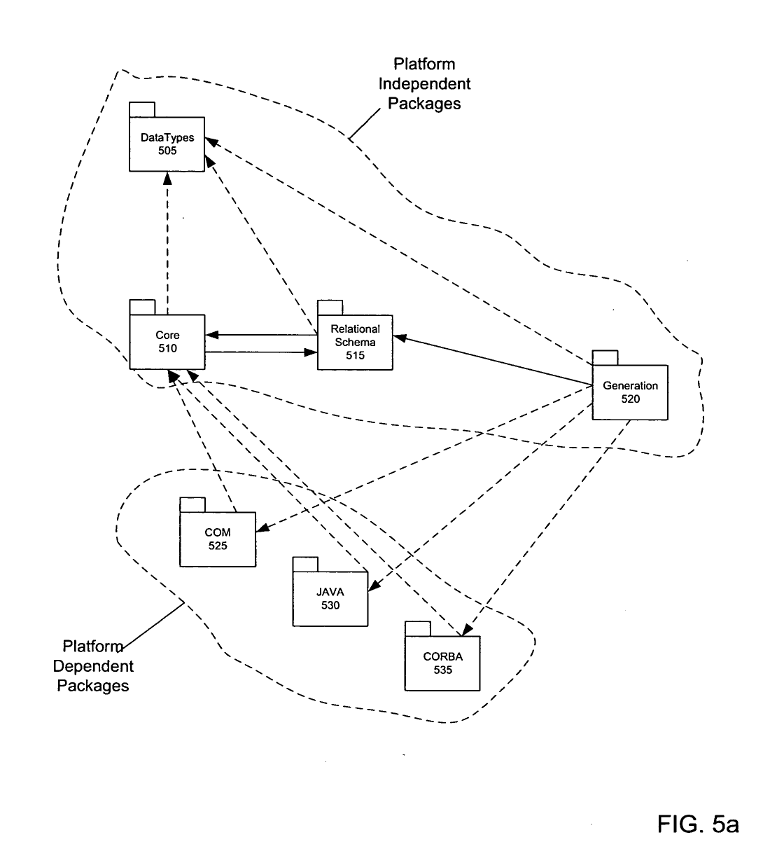

FIG. 5a depicts a M2 model for an object repository according to one embodiment of the present invention. As shown in FIG. 5a, M2 model 310 includes a set of platform independent packages and a set of platform dependent packages. Thus, as shown in FIG. 5a, platform independent packages include “DataTypes” 705, “Core” 510, “Relational Schema” 515 and “Generation” 515. Platform independent packages include “COM” 525, “JAVA” 530 and “CORBA” 535.

“DataTypes” 705 contains data types utilized by the repository M2 model. All data types that are persistable by repository 170 will have a data type mapping in the M1 model. According to one embodiment these are referred to as<<primitive>>DataTypes. All DataTypes marked with the <<M2>> or <<enumeration, M2>> stereotype are used to define the M2 model only. As will become evident as the invention is further described, the repository core provides built-in support for <<M2>> types in order to support a meta-repository.

According to one embodiment, the DataTypes package 505 includes the following meta-classes:

| Meta-Class | Description |
|---|---|
| DataTypemapping | Defines the mapping of data type names |
| | used in the different physical representations |
| | of DataType. This mapping is required for |
| | each DataType that is to be persisted using |
| | the repository. Since the repository core has |
| | to implement the datatype support, only |
| | Datatypes can be mapped that are supported |
| | for persistency by the repository core. |
| ChangeableKind | Allows freezing of model elements. |
| VisibilityKind | Controls visibility of ScopedElement |
| LanguageKind | Implementation languages for Expression |
| ParameterDirectionKind | Defines if Parameter is an input, output, |
| | input and output or return parameter |
| AggregationKind | Used to define aggregating association |
| OrderingKind | Used to define order of AssociationEnd |
| PlatformKind | Interface technologies used by repository to |
| | expose its interfaces |
| ImplementationKind | Defines how a Method which implements an |
| | Operation is to be used by the generator |
| Multiplicity and | Define multiplicity of AssociationEnd, |
| MultiplicityKind | Attribute and Parameter |

According to one embodiment, the Core package includes the following meta-classes:

| Meta-Class | Description |
|---|---|
| ModelElement | An abstraction from the system being |
| | modeled and the base for all modeling meta- |
| | classes. Abstract meta-class. |
| Implementation | Allows extension of ModelElements by |
| Specification | defining additional meta-classes needed for |
| | implementation of the model for a specific |
| | platform (interface technology). |
| Model | Abstraction of the system being modeled. |
| | Contains all the ModelElements. |
| GeneratedProject | Abstraction of the projects being generated |
| | from the actual M1 model |
| Relationship | A connection between ModelElements. |
| | Abstract meta-class. |
| ScopedElement | Abstraction of all ModelElements, which |
| | can control their visibility. Abstract meta- |
| | class. |
| Method | Implementation of an Operation. It specifies |
| | the algorithm or procedure that effects the |
| | result of an operation. |
| Constraint | BooleanExpression on an Associated |
| | ModelElement(s). |
| Inheritance | Taxonomic relationship between a more |
| | general element and a more specific element. |
| | The more specific element is fully consistent |
| | with the more general element and may |
| | contain additional information. |
| Association | Defines a semantic relationship between |
| | Classifiers such as Classes. An Association |
| | has exactly two AssociationEnds. Each end |
| | is connected to a Classifier. The Association |
| | represents a set of connections among |
| | instances of the Classifiers. |
| AssociationEnd | Is part of an Association and specifies the |
| | connection of an Association to a Classifier. |
| Classifier | Declares a connection of Features such as |
| | Attributes and Operations. It has a unique |
| | name. Abstract meta-class. |
| DataType | Is a type whose values have no identity. |
| | DataTypes includes a primitive built-in types |
| | as well as enumeration types. |
| Interface | Contains a set of Operations that together |
| | define a service offered by a Classifier |
| | realizing the Interface. |
| Class | Describes a set of objects sharing a |
| | collection of Features, including Operations, |
| | Attributes, Methods, that are common to a |
| | set of objects. A Class defines the data |
| | structure of objects although some Classes |
| | may be abstract (no instantiable). Each |
| | object contains its own set of values |
| | corresponding to the Attributes declared in |
| | the full descriptor. |
| Feature | Declares a behavioral or structural |
| | characteristic of an instance of a Classifier. |
| Attribute | Is a named piece of the declared state of a |
| | Classifier, particularly the range of values |
| | that instances of the Classifier may hold. |
| Operation | Specifies a behavioral aspect of Classifiers |
| | that can be applied to instances of the |
| | Classifier that contains the Operation. An |
| | Operation is implemented is implemented by |
| | one or more Methods. Arguments passed to |
| | or returned from an Operation are declared |
| | using Parameters. |
| Expression | Defines a statement which will evaluate to a |
| | set of instances when executed in context. |
| | An Expression does not modify the |
| | environment in which it is evaluated. An |
| | Expression contains an expression string and |
| | the name of an interpretation language with |
| | which to evaluate the string. |
| Procedure Expression | Defines a statement which will result in a |
| | change to the values of its environment |
| | when it is evaluated. |
| Boolean Expression | Defines a statement which will evaluate to |
| | an instance of Boolean when it is evaluated. |
| Event | An Event is a specification of a type of |
| | observable occurrence. An Event may be |
| | raised by a Classifier. Its parameter list |
| | defines the data that will be passed to any |
| | subscribed event handler for an Event |
| | instance. |
| Exception | An Exception is a signal raised by |
| | Operations (which are part of a Classifier) in |
| | case of execution faults. The context of an |
| | Exception is given by the Operation it was |
| | raised by. An exception may define |
| | Attributes (it inherits from Classifier) to |
| | define data that will be passed to any |
| | subscribed exception handler for an |
| | exception instance. |

A M1 model class may have a Namescope instance in order to restrict the Name attribute of instances of M1 model classes to be unique for all instances (in M0) reachable by following all possible paths in M0 defined by the AssociationPaths in the given Namescope instances (which is defined in M1). An AssociationPath is defined in M1 giving a path expression (in Rational Rose) defining a sequence of AssociationEnds (end of associations in M1).

The package RelationalSchema 515 allows the definition of the mapping of the classes defined in the M1 model to the relational schema of the underlying relational database used to persist the objects.

| Meta-Class | Description |
|---|---|
| Table | Abstraction of a relational database table |
| Column | Abstraction of a column of a relational |
| | database table. The type of the column is |
| | defined through the type of its associated |
| | attribute. The type used internally in the |
| | database system is defined by the |
| | DataTypeMapping associated to any |
| | DataType which is persistable. |
| Index | Abstraction of an index defined on a |
| | relational database table. |

The package COM 525 provides some additional classes for the definition of meta-data needed for the repository generation for the interface technology platform COM (e.g., classes for which some GUIDs are necessary to allow generation of binary compatible COM classes and interfaces.

| Meta-Class | Description |
|---|---|
| ComGenerated | Defines COM library ID and project ID for |
| ProjectImplSpec | the meta-class GeneratedProject. |
| ComClassImplSpec | Defines COM class Ids and COM interface |
| | IDs for meta-class Class |
| ComOperationImplSpec | Defines enumeration ID for meta-class |
| | Operation used in IDL |

The package Generation 525 specifies the generation process itself.

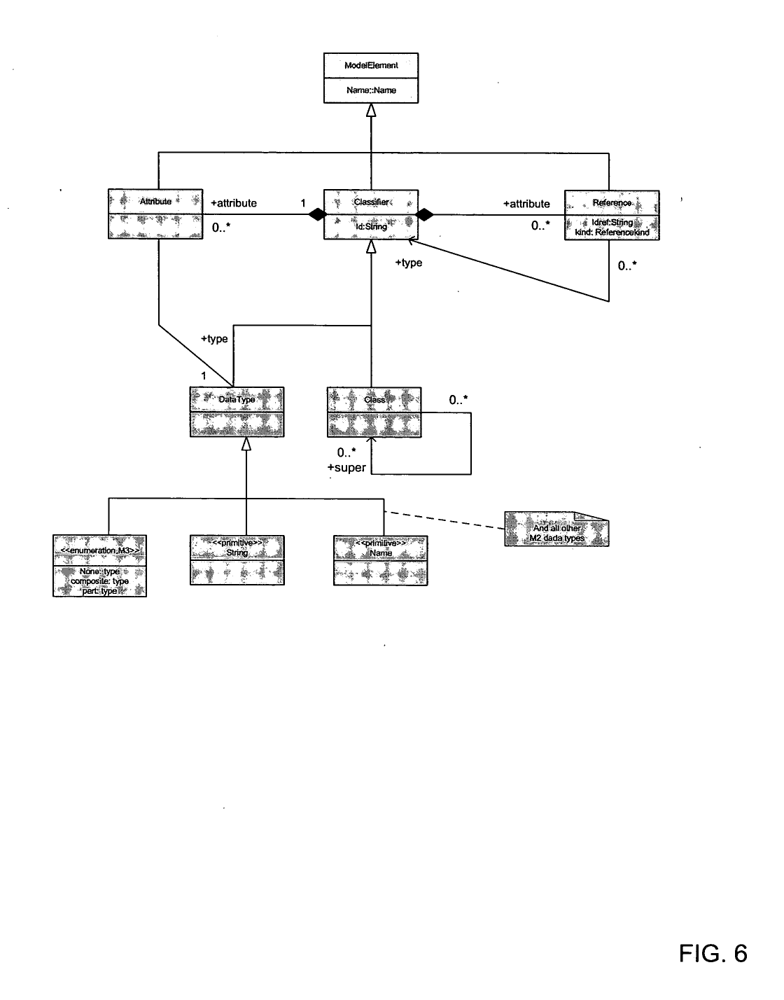

FIG. 6 depicts an M3 model used to define an XML meta-data schema according to one embodiment of the present invention.

According to one embodiment of the present invention, the M3 classes which are used to define the M2 model are mapped to XML.

| Meta | | |
|---|---|---|
| Level | Artefact | XML Representation |
| M3 | Class | <<...m3:type=”Class” m3:id=”735”...>, the XML attribute m3:id |
| | | is a unique identifier (the corresponding Rational Rose unique |
| | | identifier will be used for that) used to implement M3 References |
| M3 | Reference | The M2 type the references refers to is given with the XML |
| | | attribute type, e.g., a reference is used to define the association to a |
| | | M2 ModelElement is given as (it refers to the M3 class with m3:id = “735”): |
| | | <...m3:type=”Reference” m3:kind=”part” |
| | | m3:idref=”735” type=”ModelElement”...> |
| M3 | Name | The M3 name attribute is displayed as XML element name, e.g., |
| | Attribute | for AssociationEnd in M2: <AssociationEnd m3:type=”Class” |
| | | m3:id=”878”...> |
| | | </AssociationEnd> |
| M3 | Attribute | No M3 type is given in XML (m3:type=”Attribute” is omitted). |
| | | Actual attributes (instances of M3 Attribute in M2) are displayed |
| | | as nested XML elements. Attribute types are given as XML |
| | | attribute type: <AssociationEnd m3:type=”Class” m3:id=”878”> |
| | | <isNavigable type=”Boolean”>true</isNavigable> |
| | | ... |
| | | </AssociationEnd> |
| M3 | Super class | Given by nesting of XML elements (most derived class encloses |
| | relation of M3 | its base class contents), only the most derived class uses the m3:id |
| | Class | attribute (because the most derived class defines the identity) |
| | | <Class m3:type=”Class” m3:id=”8789”> |
| | | <Classifier m3:type=”Class”> |
| | | <ModelElement m3:type=”Class”> |
| | | ... |
| | | </ModelElement> |
| | | ... |
| | | </Classifier> |
| | | ... |
| | | </Class> |

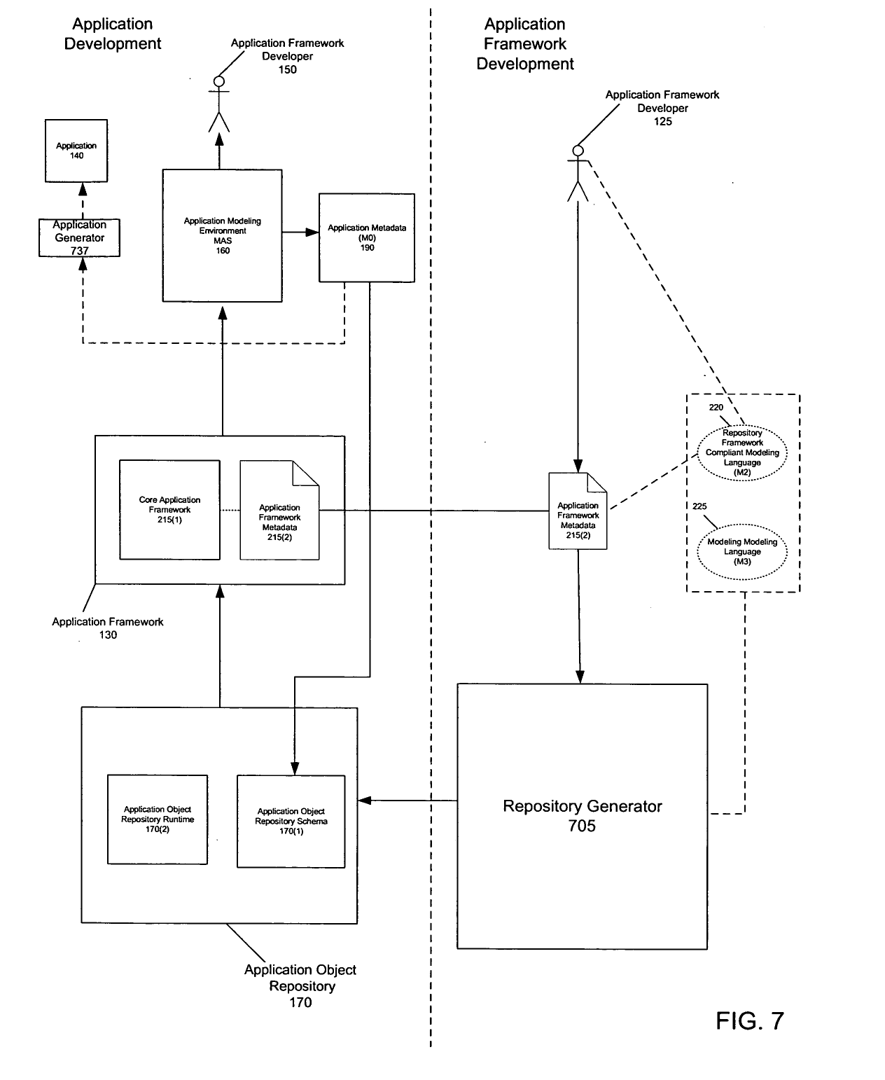

FIG. 7 depicts a functioning of a repository generator in relation to an application framework development environment and an application development environment according to one embodiment of the present invention. Application framework developer 125 generates application framework metadata 215(2) utilizing repository framework compliant modeling language (M2) 220, which is received by repository generator 705. Repository generator 705 generates application object repository 170 as a function of repository framework compliant modeling language (M2) 220 and modeling modeling language (M3) 225. Application object repository 170 includes application object repository schema 170(1) and application object repository runtime 170(2). Application object repository schema 170(1) may be a relational database for storing application metadata 190. Application object repository runtime may be actual executable binaries 170(2), i.e., executable routines for providing services for object oriented interaction with application object repository database 170(1). These services may include versioning, change-management, persistence, navigation, etc.

Application developer 150 develops application metadata 190 via application modeling environment 160 utilizing constructs provided by application framework, which includes core application framework 215(1) and application framework metadata 215(2). As noted above, the developed application metadata 190 is stored in application object repository 170 and ultimately utilized to generate application 140 via application generator 737.

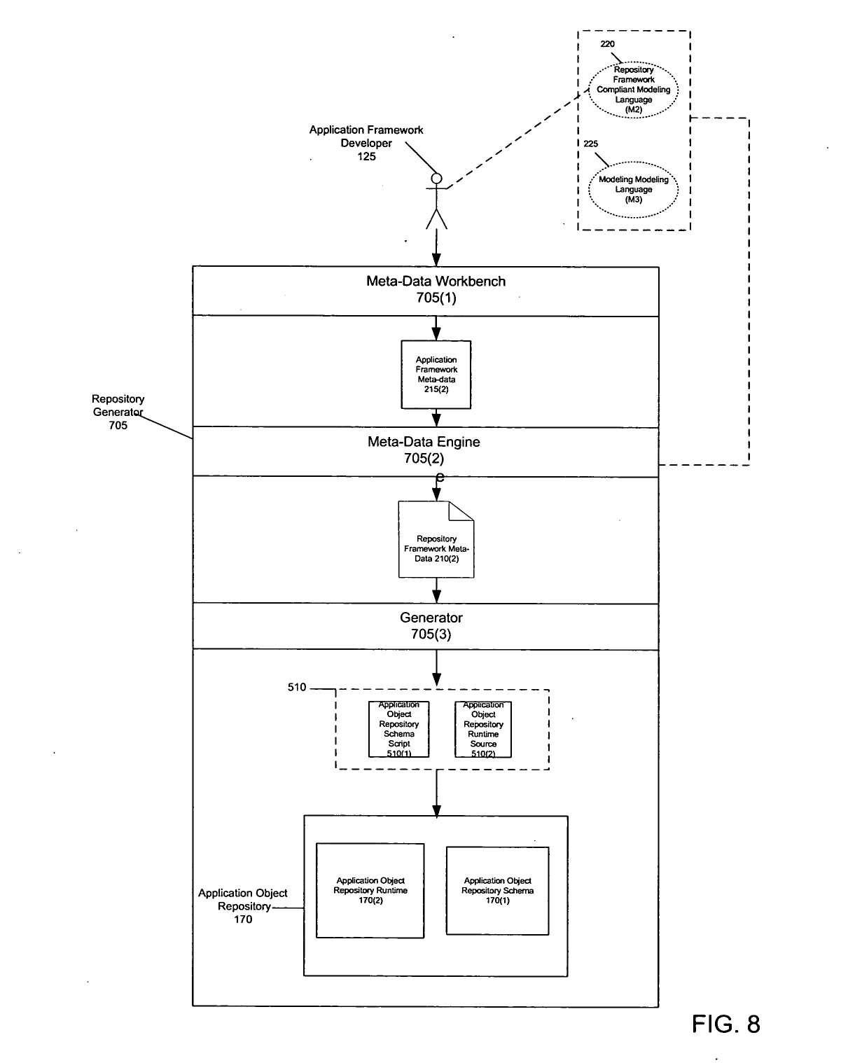

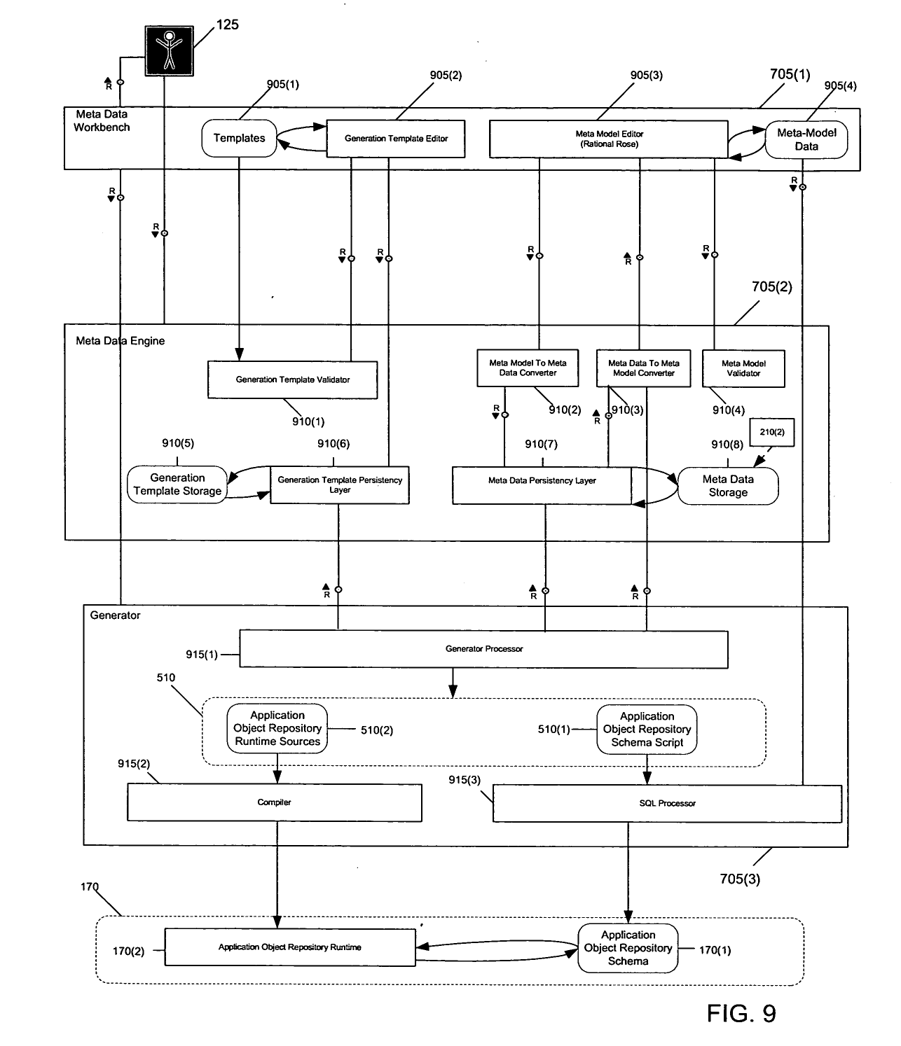

FIG. 8 depicts a detailed functioning of repository generator 705. Repository generator 705 includes meta-data workbench 705(1), meta-data engine 705(2) and generator 705(3). Application framework developer 125 utilizes meta-data workbench 705(1) to generate application framework meta-data 215(2) as a function of repository framework compliant modeling language (M2) 220. Meta-data workbench 705(1) may provide a GUI (“Graphical User Interface”) for receiving a visual representation of application framework meta-data 215(2). According to one embodiment, meta-data workbench 705(1) is designed to receive a UML representation of application framework meta-data 215(2). According to this embodiment, the core constructs of UML are extended to include constructs provided by M2 meta-level 310 (i.e., utilizing repository framework compliant modeling language (M2) 220).

Meta-data engine 705(2) receives application framework meta-data 215(2) and transforms the application framework meta-data 215(2) into repository framework meta-data 210(2) utilizing the constructs of repository framework compliant modeling language (M2) 220 and modeling-modeling language (M3) 225. According to one embodiment of the present invention, repository framework meta-data is represented utilizing XML. Repository framework meta-data 210(2) serves as an intermediate representation, which ultimately is used via generator 705 to generate application object repository 170. However, this is merely exemplary and any other format may be utilized. The details of this transformation and an exemplary scenario will be described below.

Generator 705(3) receives repository framework meta-data 210(2) and generates source files 510, which includes application object repository schema script 510(1) and application object repository runtime source 510(2). Application object repository schema script 510(1) is utilized to generate application object repository schema 170(1). Application object repository source 510(2) represents source files, which are compiled or otherwise utilized to generate application object repository runtime 170(2). Application object repository schema 170(1) and application object repository runtime 170(2) comprise application object repository 170.

FIG. 9 shows a detailed architecture for a repository generator according to one embodiment of the present invention. As shown in FIG. 9, repository generator includes meta-data workbench 705(1), meta-data engine 705(2) and generator 705(3). As noted with respect to FIG. 8, application framework developer 125 utilizes meta-data workbench 705(1) to generate application framework meta-data 215(2) using repository framework compliant modeling language (M2) 220. According to one embodiment, the data representing application framework meta-data is received and stored in a format compatible with meta-model editor.

Meta-data workbench 705(1) includes templates 905(1), generation template editor 905(2) and meta-model editor 905(3). According to one embodiment application framework developer 125 utilizes meta-model editor 905(3) to define M1 meta-data using a repository framework compliant modeling language (M2). According to one embodiment, meta-model editor 905(3) is a visual model editor such as Rational Rose or Visio. Meta-model data 905(5), which relates to application framework meta-data 215(2) (M1 level) is defined via meta-model editor 905(3) and stored as meta-model data 905(4) in a format compatible with meta-model editor 905(3). Thus, for example, if meta-model editor 905(3) is Rational Rose, application framework meta-data 215(2) representing application framework meta-data in a format compatible with Rational Rose.

Application framework developer 125 (not shown in FIG. 9) also utilizes generation template editor 905(2) to define transformation templates 905(1), which are validated by generation template validator 910(1) and provided to generation template persistency layer 910(6) for storage in generation template storage 910(5). Templates 905(1) will be utilized to transform repository framework meta-data 210(2) into repository 170 itself as will become evident as the invention is further described. According to one embodiment, templates are XSL templates, which are used to transform XML data, which serves as an intermediate representation of meta-data model 905(4).

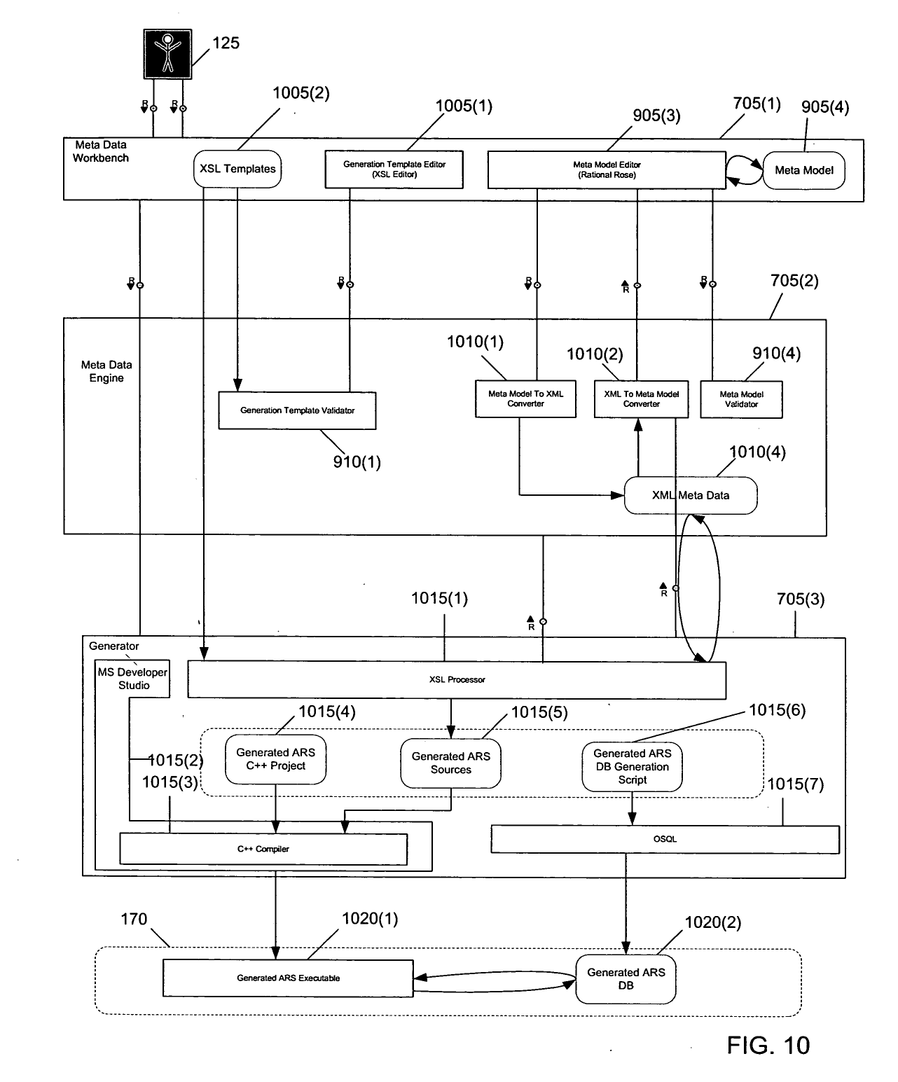

Meta-model data 905(4) is received by meta-model validator 910(4), which determines whether all modeling constructs are valid with respect to repository framework compliant modeling language 220. Meta-model to meta-data converter 910(3) receives meta-model data 905(4) and transforms the meta-model data into repository framework meta-data 210(2), which is stored via meta-data persistency layer 910(7) in meta-data storage 910(8). Meta-data to meta-model converter 910(3) provides a mechanism for conversion of repository framework meta-data 210(2) to be converted back to meta-model data 905(4) if necessary. According to one embodiment of the present invention, described in detail with respect to FIG. 10, repository framework meta-data is represented as XML which it is stored in meta-data storage 910(8) via meta-data persistency layer 910(7). Similarly templates 905(1) are validated by generation template validator 910(1) and are then stored in generation template storage 905(1) via generation template persistency layer 910(6).

Generator processor 915(1) in generator 705(3) performs transformations on application framework meta-data 210(2) received via meta-data persistency layer 910(7) utilizing templates 905(1) provided via generation template persistency layer 910(6) to generate source files 510, which include application object repository runtime sources 510(2) and application object repository schema script 510(1). Application object repository schema script 510(1) and application object repository runtime sources 510(2) are respectively received by SQL processor 915(3) and compiler 915(2) to generate application object repository schema 170(1) and application object repository runtime 170(2) comprising application object repository 170.

FIG. 10 depicts a generator utilizing XML/XSL technology according to one embodiment of the present invention. The components shown in the generator architecture of FIG. 10 is similar to the generator architecture shown in FIG. 9, except the generator 705 has been adapted to use XML technology specifically for representation of the repository framework meta-data 210(2). For example, generation template editor 905(2) is now replaced by XSL editor 1005(1) and meta-model to meta-data converter 910(2) is replaced by meta-model to XML converter 1010(1), etc. In addition, the generated object repository 170 pertains in particular to a particular object repository referred to herein as ARS (“Application Repository Services”), which includes generated ARS executable 1020(1) and generated ARS DB corresponding to application object repository runtime 170(2) and application object repository schema 170(1).

Furthermore, the embodiment depicted in FIG. 10 specifically shows the use of C++ for the representation of the source files for ARS executable 1020(1) (i.e., 1015(3) and 1015(4)) as well as the use of OSQL 1015(7) (“Object Oriented SQL”).

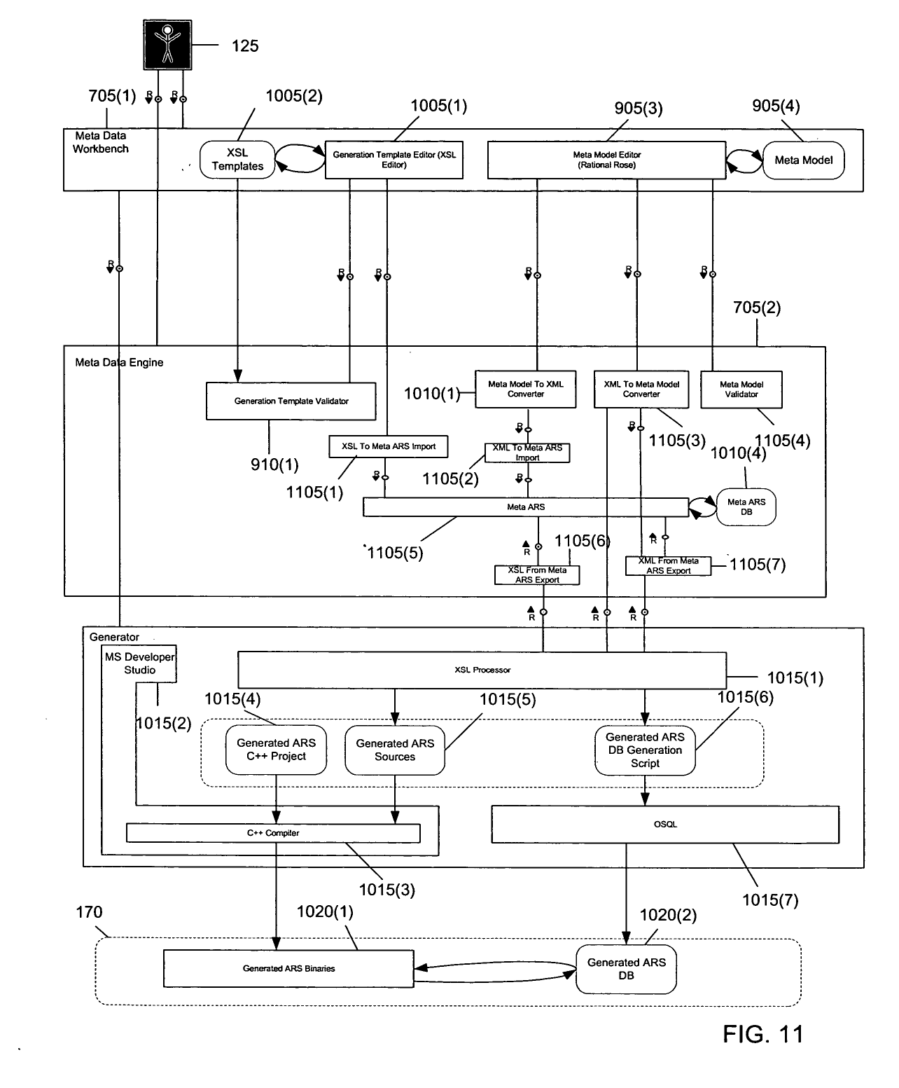

FIG. 11 depicts a meta-framework repository generator according to one embodiment of the present invention. The generator architecture shown in FIG. 11 is designed to allow the construction of generic migration tools. Although the specific embodiment shown in FIG. 11 employs the use of XML/XSL technology and relates to the generation of a specific object repository database ARS (see FIG. 11), it is to be understood that the meta-framework repository generator may be used with any type of transformation or technology for the representation of meta-data. Furthermore, although FIG. 11 relates to the generation of a specific object repository database ARS, it is to be understood that the invention may be used for the generation of any type of object repository.

FIG. 11 shows the use of meta-ARS 1105(5), which is designed to store a history of ARS models (i.e., object repository models). By storing a history of ARS models, meta-data previously generated and stored in ARS database 1020(2) may then be migrated to conform to the structure of subsequently developed ARS object repositories. This is accomplished via XML to meta-ARS import 1105(2) block, which imports an XML meta-model into a format compatible with storage in meta-ARS database 1010(4). Also provided are XSL from meta-ARS export 1105(6) and XML from meta-ARS export 1105(7), which allows exportation of previously defined object repository structures from meta-ARS 1105(5).

1. A method for generating a software development repository to reflect extensions in an application framework comprising:
defining a repository framework;
receiving application framework metadata, the application framework metadata specified utilizing constructs from an application framework meta-level (M2);
transforming the application framework metadata into an intermediate representation as a function of the application framework meta-level (M2) and a meta-level for the application framework meta-level (M3);
generating the software development repository utilizing the intermediate representation.

2. The method according to claim 1, wherein the intermediate representation is XML (“Extensible Markup Language”).

3. The method according to claim 1, wherein the software development repository includes a database schema and an executable component, the executable component providing at least one database service.

4. The method according to claim 3, wherein the at least one service includes object oriented access, versioning, persistence and change management.

5. The method according to claim 2, wherein the step of transforming the application framework into an intermediate representation is achieved using XSL (“Extensible Style Language”).

6. The method according to claim 1, wherein the step of generating the software development repository further includes the steps of generating a source file for generating an executable component and a script file for generating a database schema.

7. A method for generating a software development repository to reflect changes in an application framework comprising:
providing a first meta-level (M2) for representing the application framework metadata;
providing a second meta-level (M3) for representing the M2 meta-level;
receiving application framework metadata, the application framework metadata specified utilizing constructs from the application framework meta-level (M2);
transforming the application framework metadata into an intermediate representation as a function of the application framework meta-level (M2) and the second meta-level level (M3);
generating the software development repository as a function of the intermediate representation.

8. The method according to claim 7, wherein the intermediate representation is XML.

9. The method according to claim 7, wherein the software development repository includes a database and an executable component, the executable component providing at least one service with respect to the database.

10. The method according to claim 9, wherein the at least one service includes versioning, change management, persistence and change management.

11. An object repository generator comprising:
an interface for receiving a meta-model specification;
a metadata engine for performing at least one operation on the meta-model specification including at least generating an intermediate representation of the meta-model specification as a function of a first meta-level and a second meta-level;
a generator component for generating the object repository as a function of the intermediate representation.

12. The object repository generator of claim 11, wherein the meta-model specification utilizes at least a subset of UML (“Unified Modeling Language”).

13. The object repository generator of claim 11, wherein the generator component generates a source file and an database schema script, the source file utilized to generate an executable component and the database schema script utilized to generate a database schema.

14. An object repository generator comprising:
an interface for receiving a meta-model specification;
a metadata engine for performing at least one operation on the meta-model specification including at least generating an intermediate representation of the meta-model specification as a function of a first meta-level and a second meta-level, the meta-data engine including a database for storing a plurality of versions of an object repository;
a generator component for generating the object repository as a function of the intermediate representation.

15. The object repository according to claim 14, wherein the database storing versions of an object repository is utilized to provide migration of data stored in the object repository.

16. A method for providing generic migration of previously stored data in a software development repository to reflect changes in an application framework comprising:
providing a first meta-level (M2) for representing the application framework metadata;
providing a second meta-level (M3) for representing the M2 meta-level;
receiving application framework meta-data, the application framework metadata specified utilizing constructs from the application framework meta-level (M2);
transforming the application framework meta-data into an intermediate representation as a function of the application framework meta-level (M2) and the second meta-level level (M3);
generating the software development repository as a function of the intermediate representation;
transforming the previously stored data into a format compatible with the generated software development repository utilizing the intermediate representation.
